(19) United States
(12) Patent Application Publication
(10) Pub. No.: US 2025/0270850 A1
(43) Pub. Date: Aug. 28, 2025

(54) DOOR LOCK DEVICE

(71) Applicant: FIBRE INDUSTRY CO., LTD., Hsinchu City (TW)

(72) Inventor: Chen-Yu HUNG, Hsinchu City (TW)

(21) Appl. No.: 18/919,534

(22) Filed: Oct. 18, 2024

(30) Foreign Application Priority Data
Feb. 26, 2024 (TW) 113106817

(51) Int. Cl. E05B 59/00; E05B 9/00; E05B 9/02; E05B 15/10; E05B 17/00; E05B 47/00; E05B 55/12; E05B 63/08

(52) U.S. Cl. CPC E05B 59/00; E05B 9/002; E05B 9/02; E05B 15/10; E05B 17/0045; E05B 47/0012; E05B 55/12; E05B 63/08; E05B 2047/0017; E05B 2047/002; E05B 2047/0024; E05B 2047/0054; E05B 2047/0068; E05B 2047/0084

(57) ABSTRACT

A door lock device includes a spring latch rotatably and movably disposed within a housing to be pressed to rotate and move between a projecting position, where the spring latch projects outwardly of a latch hole of the housing, and a retreated position, where the spring latch retreats inwardly into the latch hole. A retaining member is pivotably disposed to the housing, and is operable to rotate between a retaining position to engage with the spring latch to prevent rotation of the spring latch in the projecting position, and a releasing position to disengage from the spring latch. A biasing spring is disposed to bias the retaining member to the retaining position and to keep the retaining member in the retaining position.

### CROSS-REFERENCE TO RELATED APPLICATION

This application claims priority to Taiwanese Patent Application No. 113106817, filed on Feb. 26, 2024, and incorporated by reference herein in its entirety.

### FIELD

The disclosure relates to a door lock device, and more particularly to a push-and-pull door lock device.

### BACKGROUND

Conventional door locks have many components, thereby causing problems such as inconvenient fabrication, complicated construction and high manufacturing costs. Moreover, the deadbolt of a conventional door lock is prone to generate noises due to collision during the locking process, which results in discomfort and distress to users.

### SUMMARY

Therefore, an object of the disclosure is to provide a door lock device that can alleviate at least one of the drawbacks of the prior art.

According to the disclosure, the door lock device includes a housing, a spring latch and a retaining biasing assembly. The housing defines a receiving space therein, and has a latch hole in communication with the receiving space. The spring latch is rotatably and movably disposed in the receiving space adjacent to the latch hole to be pressed to rotate and move between a projecting position, where a portion of the spring latch projects outwardly of the latch hole, and a retreated position, where the spring latch retreats inwardly into the latch hole. The retaining biasing assembly is disposed within the housing, and includes a retaining member which is pivotably disposed in the housing, and a biasing spring. The retaining member is operable to rotate between a retaining position, where the retaining member is engaged with the spring latch to prevent rotation of the spring latch in the projecting position, and a releasing position, where the retaining member is disengaged from the spring latch. The biasing spring is disposed to bias the retaining member to the retaining position and to keep the retaining member in the retaining position.

### BRIEF DESCRIPTION OF THE DRAWINGS

Other features and advantages of the disclosure will become apparent in the following detailed description of the embodiment with reference to the accompanying drawings. It is noted that various features may not be drawn to scale.

FIG. 1 is a perspective view illustrating an embodiment of a door lock device according to the disclosure.

FIG. 2 is an exploded perspective view of the embodiment.

FIG. 3 is an exploded perspective view of the embodiment taken from another angle.

FIG. 4 is a fragmentary right side view of the embodiment.

FIG. 5 is a fragmentary left side view of the embodiment.

FIG. 6 is an exploded perspective view of a portion of the embodiment.

FIG. 7 is an exploded perspective view similar to FIG. 6, but taken from another angle.

FIG. 8 is a fragmentary sectional view taken along line VIII-VIII of FIG. 1.

FIG. 9 is a fragmentary sectional view taken along line IX-IX of FIG. 1.

FIG. 10 is an exploded perspective view of a portion of the embodiment.

FIG. 11 is an exploded perspective view of a portion of the embodiment.

FIG. 12 is a fragmentary right side view illustrating the embodiment in a door-opened state.

FIG. 13 is a fragmentary sectional view similar to FIG. 8, illustrating the embodiment in a door-closed state.

FIG. 14 is a fragmentary right side view illustrating a tongue in a retracted position.

FIG. 15 is a fragmentary right side view similar to FIG. 4, illustrating a deadbolt assembly in an unlocking position.

FIG. 16 is a fragmentary right side view illustrating a buffering ring in a closed position.

FIG. 17 is a fragmentary right side view similar to FIG. 16, illustrating the buffering ring in an opened position.

### DETAILED DESCRIPTION

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly. In the following description, a first horizontal direction (D1), a second horizontal direction (D2) and a vertical direction (D3) are transverse to one another. The first horizontal direction (D1) is substantially a front-rear direction, the second horizontal direction (D2) is substantially a left-right direction, and the vertical direction (D3) is substantially an up-down direction.

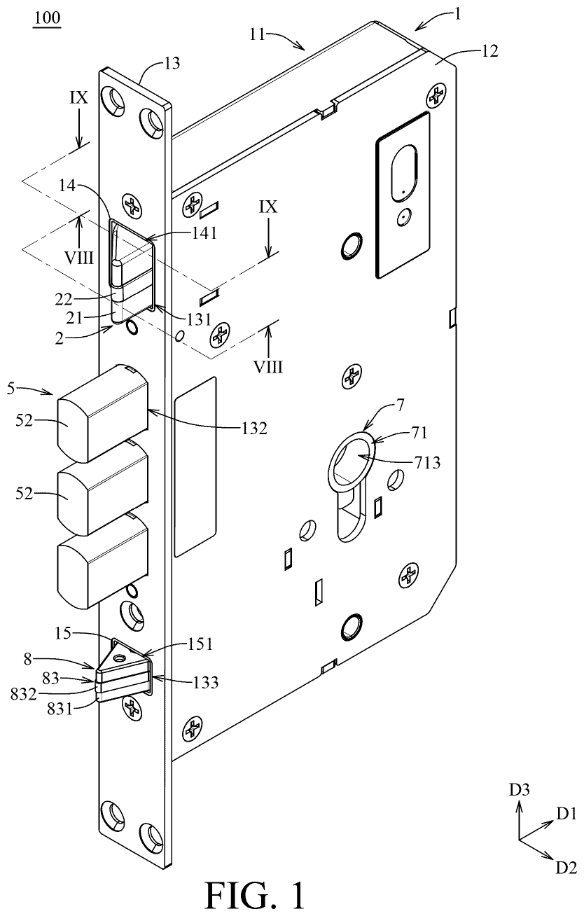

Referring to FIGS. 1 to 3, an embodiment of a door lock device 100 according to the disclosure is of a push-and-pull door lock and is adapted to be mounted in a door plate (not shown). The door lock device 100 includes a housing 1, a spring latch 2, a retaining biasing assembly 3, a speed-reduction mechanism 4, a deadbolt assembly 5, an electrically driving mechanism 6, a key driving mechanism 7 and a lock tongue mechanism 8.

The housing 1 includes a housing shell 11, a cover plate 12, a front plate 13, a buffering ring 14 and a buffering ring 15. The housing shell 11 has a right opening (11a). The cover plate 12 is coupled with the housing shell 11 to cover the right opening (11a). The front plate 13 is removably connected with front ends of the housing shell 11 and the cover plate 12 and cooperates with the housing shell 11 and the cover plate 12 to define an accommodation space 10 thereamong. The housing shell 11 has a base plate 110. The base plate 110 has two elongated slots 111 spaced apart from each other in the first horizontal direction (D1) and each extending in the first horizontal direction (D1). The front plate 13 has an upper hole 131, a plurality of deadbolt holes 132 formed below the upper hole 131 and spaced apart from each other in the vertical direction (D3), and a lower hole 133 formed below the deadbolt holes 132. The buffering ring 14 defines a latch hole 141 extending therethrough, and is mounted on the front plate 13 to align the latch hole 141 with the upper hole 131. The buffering ring 15 defines a tongue hole 151 extending therethrough, and is mounted on the front plate 13 to align the tongue hole 151 with the lower hole 133. Each of the buffering rings 14, 15 is made of an elastomeric material, such as rubber, silicone, etc.

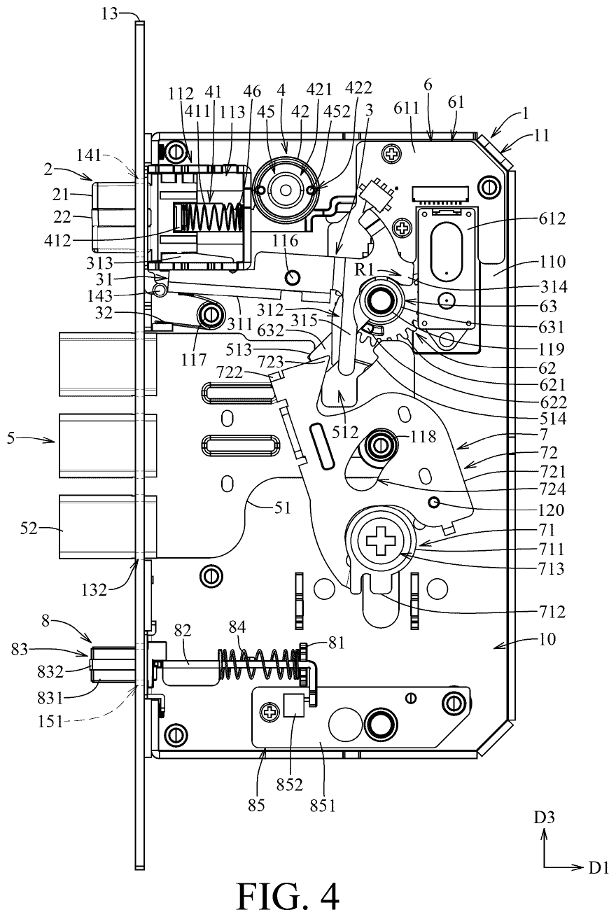

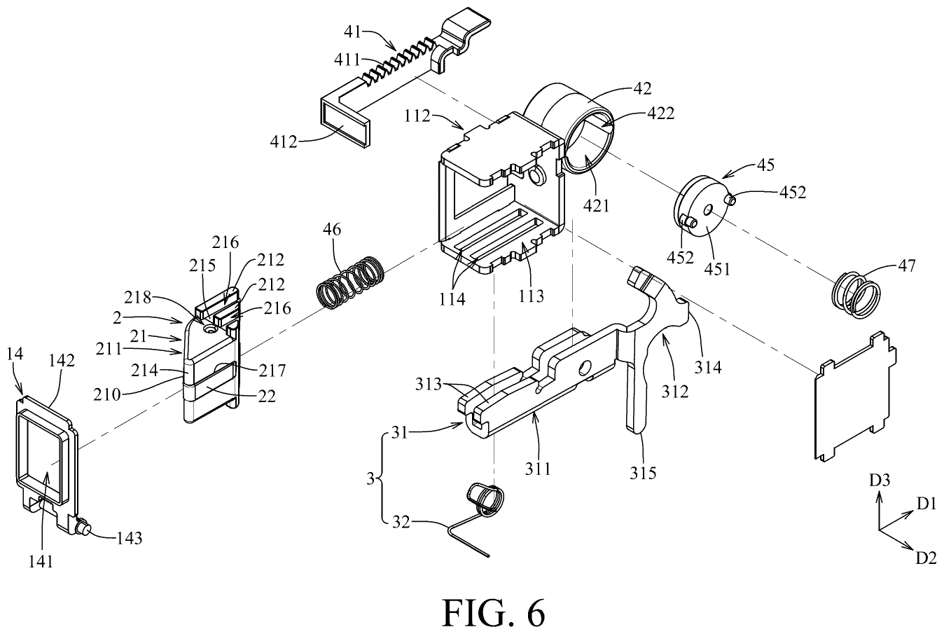

With reference to FIGS. 4, 5 and 6, the housing shell 11 further has a support frame 112 disposed on the base plate 110 adjacent to the buffering ring 14. The support frame 112 has a receiving space 113 therein in communication with the latch hole 141, two elongated holes 114 in communication with a bottom of the receiving space 113 and spaced apart from each other in the second horizontal direction (D2), and a through hole 115 in communication with the receiving space 113 at an end opposite to the latch hole 141. Each elongated hole 114 extends in the first horizontal direction (D1). The housing shell 11 further has an axle shaft 116 disposed on the base plate 110 downwardly and rearwardly of the support frame 112, and a threaded socket 117 disposed on the base plate 110 downwardly of the support frame 112.

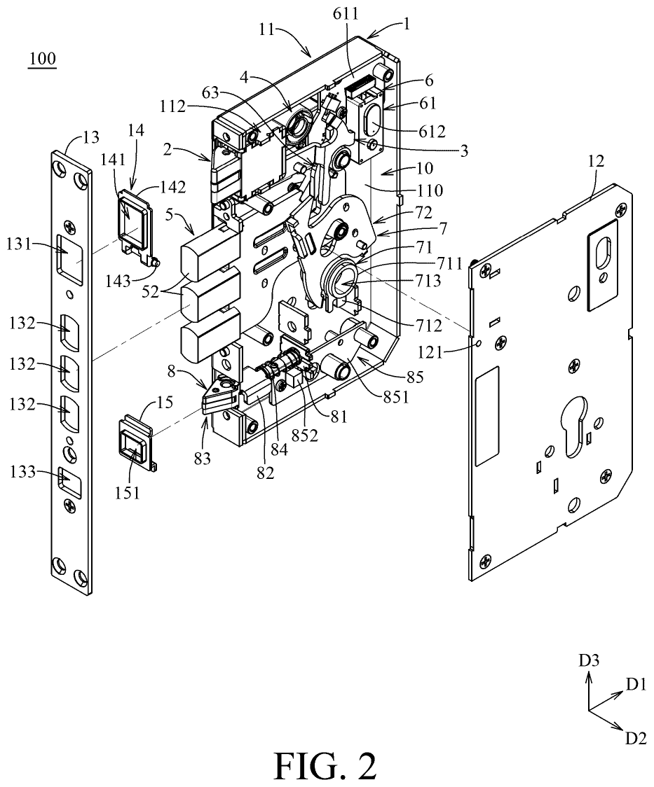

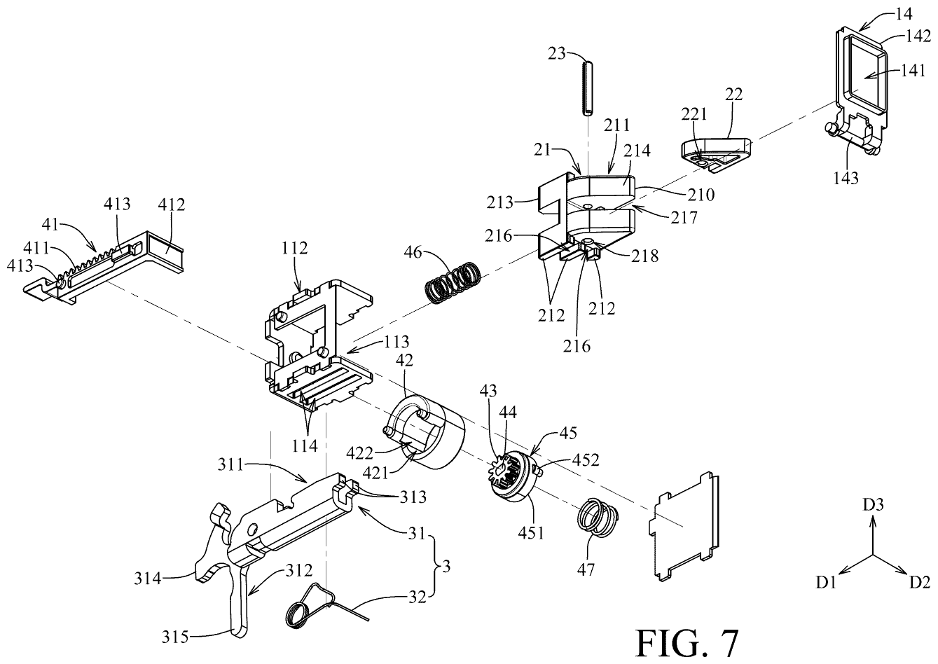

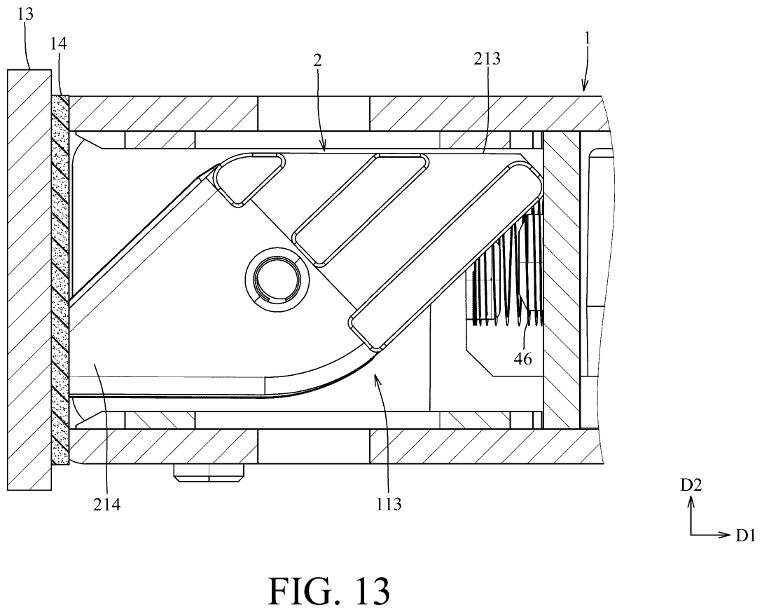

With reference to FIGS. 2, 4, 6 and 7, the spring latch 2 is rotatably and movably disposed in the receiving space 113 adjacent to the latch hole 141 to be pressed to rotate and move between a projecting position (as shown in FIG. 4), where a portion of the spring latch 2 projects outwardly of the latch hole 141, and a retreated position (as shown in FIG. 13), where the spring latch 2 retreats inwardly into the latch hole 141. The spring latch 2 has a diamond-shaped cross-section, and is removably disposed within the housing 1 such that the spring latch 2 is selectively disposed in the receiving space 113 in one of a head-side direction and a tail-side direction which is opposite to the head-side direction by a 180-degree spin. Thus, the door lock device 100 may be applied to both the inward-opening door and the outward-opening door.

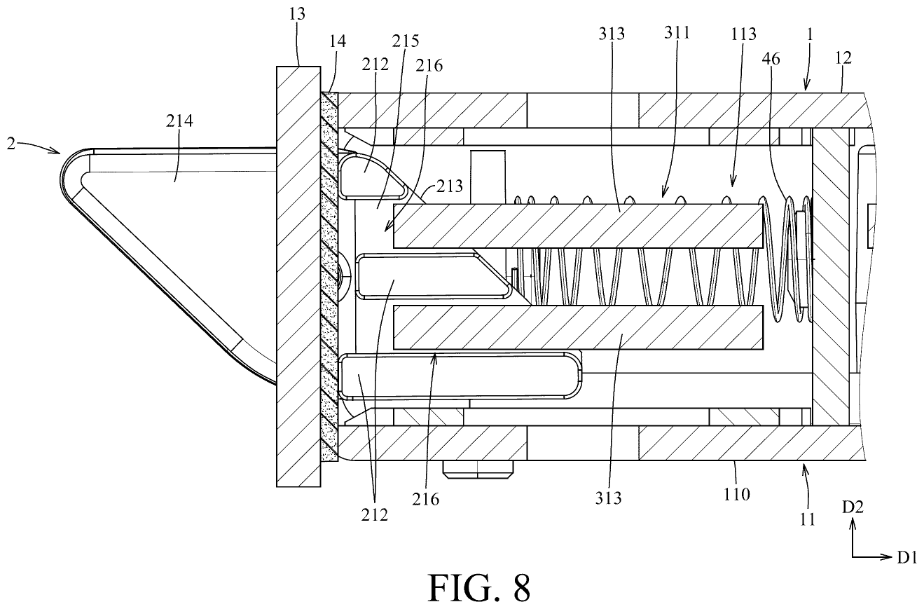

With reference to FIGS. 4, 6, 7 and 8, the spring latch 2 includes a latch body 21, a buffering pad 22 and an insert pin 23. The latch body 21 has a diamond-shaped body 211 and at least two pairs of the protrusions 212. The diamond-shaped body 211 has a triangular inner part 213 and a triangular outer part 214 extending from the inner part 213. The inner part 213 is disposed in the receiving space 113 and has first and second side surfaces 215 opposite to each other in the vertical direction (D3). Three protrusions 212 project from the first side surface 215 and are spaced apart from one another in the second horizontal direction (D2) to cooperatively define two first grooves 216, and three protrusions 212 project from the second side surface 215 and are spaced apart from one another in the second horizontal direction (D2) to cooperatively define two second grooves 216. Hence, the first grooves 216 extend in the first horizontal direction (D1) and are spaced apart from each other in the second horizontal direction (D2), and the second grooves 216 extend in the first horizontal direction (D1) and are spaced apart from each other in the second horizontal direction (D2). The outer part 214 has a projecting end 210 projecting outwardly of the latch hole 141, a recess 217 recessed from the projecting end 210, and an insert hole 218 in communication with the recess 217 and extending in the vertical direction (D3). The buffering pad 22 is made of an elastomeric material, such as rubber, silicone, etc., and is engaged in the recess 217 and partly projects from the outer part 214 so as to contact a door frame (not shown). The buffering pad 22 has a through hole 221 which is aligned with the insert hole 218. The insert pin 23 is engaged with and extends through the insert hole 218 and the through hole 221 to interfere with the outer part 214 and the buffering pad 22 so as to retain the buffering pad 22 on the latch body 21.

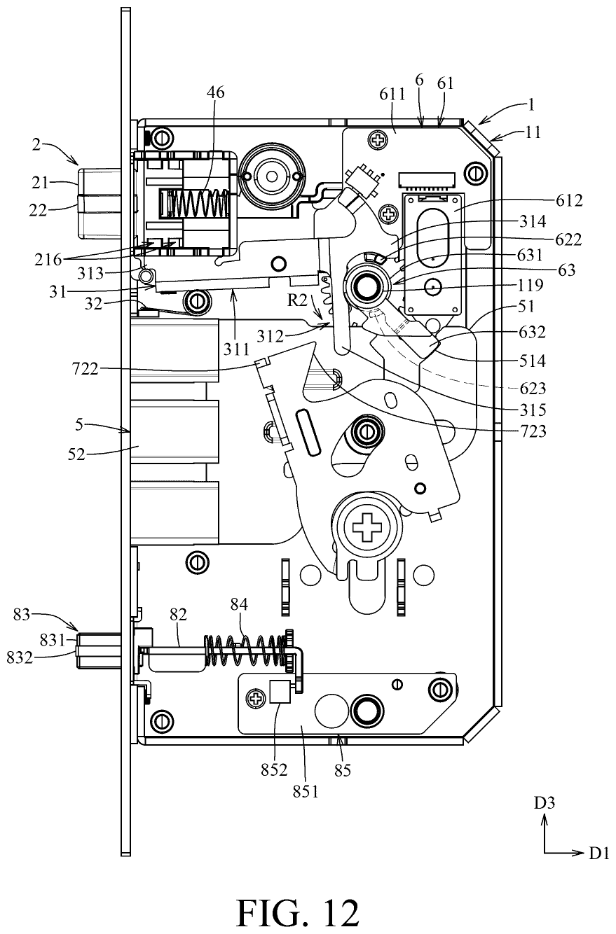

With reference to FIGS. 4, 5, 6, 7 and 8, the retaining biasing assembly 3 is disposed in the accommodation space 10 of the housing 1, and includes a retaining member 31 and a biasing spring 32. The retaining member 31 is pivotably disposed on the axle shaft 116 of the housing 1, and is operable to rotate between a retaining position (as shown in FIG. 4), where the retaining member 31 is engaged with the spring latch 2 to prevent rotation of the spring latch 2 in the projecting position, and a releasing position (as shown in FIG. 12), where the retaining member 31 is disengaged from the spring latch 2. The biasing spring 32 is disposed to bias the retaining member 31 to the retaining position and to keep the retaining member 31 in the retaining position.

The retaining member 31 is an integrally formed single piece made by punching and bending machining processes. The retaining member 31 has a retaining shaft 311 disposed to retain the spring latch 2, and a pressed shaft 312 extending from the retaining shaft 311. The retaining shaft 311 has a U-shaped cross-section, and has two retaining ribs 313 spaced apart from each other in the second horizontal direction (D2) and each extending in the first horizontal direction (D1) to extend through the corresponding elongated hole 114 and to be engaged with the corresponding groove 216 of the spring latch 2. The pressed shaft 312 has a transverse shaft section 314 extending rearwardly from the retaining shaft 311, and an upright shaft section 315 extending transverse to and downwardly from the transverse shaft section 314.

When the retaining member 31 is in the retaining position, the retaining ribs 313 are respectively engaged in the corresponding grooves 216 so as to restrict rotation of the spring latch 2 in the projecting position. When the retaining member 31 is in the releasing position, the retaining ribs 313 are disengaged from the corresponding grooves 216 to permit rotation of the spring latch 2 in the projecting position. With the first and second grooves 216 formed in the opposite first and second side surfaces 215, the spring latch 2 may be disposed in the head-side direction so that the first grooves 216 may engage with the retaining ribs 313, and the spring latch 2 may also be disposed in the tail-side direction so that the second grooves 216 may engage with the retaining ribs 313. Therefore, the spring latch 2 may be disposed in a selected one of the head-side direction and the tail-side direction, and the retaining member 31 is disposed to retain the spring latch 2 in the projecting position.

The biasing spring 32 is a torsion spring which is sleeved around the threaded socket 117, and has two ends abutting against the housing shell 11 and a bottom of the retaining shaft 311.

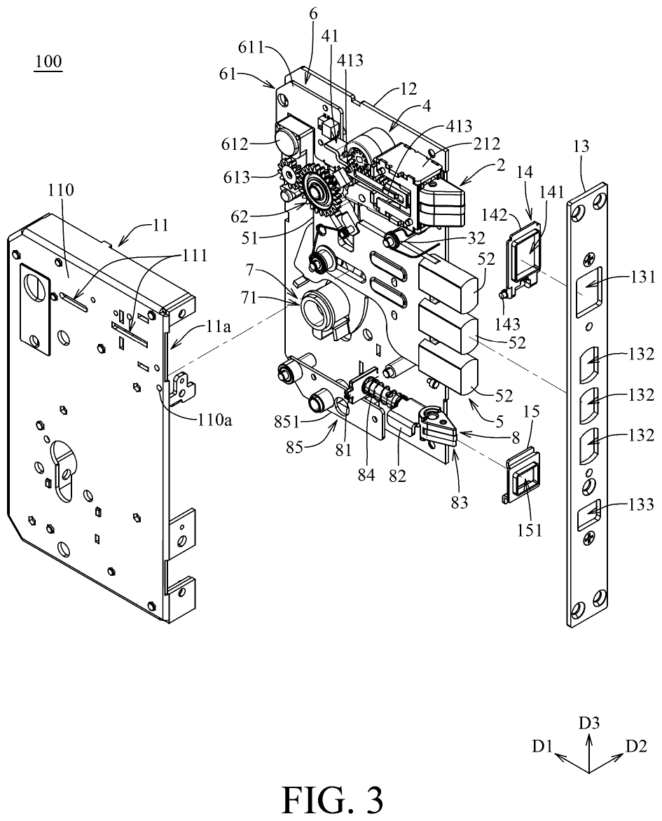

With reference to FIGS. 4, 5, 6, 7 and 9, the speed-reduction mechanism 4 is disposed in the accommodation space 10 of the housing 1, and includes a rack 41, a sleeve 42, a pinion 43, a pinion shaft 44, a bearing 45, a first compression spring 46 and a second compression spring 47. The rack 41 has a rack section 411, an abutting section 412 and two sliding sections 413. The rack section 411 extends in the first horizontal direction (D1) and through the through hole 115 of the support frame 112. The abutting section 412 is connected with a front end of the rack section 411 and extends in the second horizontal direction (D2) to be disposed in the receiving space 113 of the support frame 112 and abut against the inner part 213 of the spring latch 2. The sliding sections 413 extend from a left side of the rack section 411 and respectively and slidably engaged in the elongated slots 111 of the housing 1 (see FIG. 3) so as to restrain the movement of the rack 41 only in the first horizontal direction (D1). The rack 41 is moved by spring latch 2 through the abutting engagement of the abutting section 412 with the inner part 213.

The sleeve 42 is disposed on the base plate 110 of the housing shell 11 and rearwardly of the support frame 112. The sleeve 42 has a sleeve wall 421, two engaging slots 422 formed in the sleeve wall 421 spaced apart from each other in the first horizontal direction (D1), and an abutting surface 423 formed in and transverse to the sleeve wall 421 adjacent to the left side of the sleeve wall 421. The pinion 43 and the pinion shaft 44 are received within the sleeve wall 421. The pinion 43 is securely sleeved on the pinion shaft 44 and meshes with the rack section 411 of the rack 41. The bearing 45 has a bearing body 451 received within the sleeve wall 421 to bear the pinion shaft 44, and two engaging ribs 452 extending from the bearing body 451 and respectively engaged with the engaging slots 422 of the sleeve 42 so as to prevent rotation of the bearing 45 relative to the sleeve 42.

The first compression spring 46 is received in the receiving space 113 of the support frame 112, and has two ends in abutting engagement with the abutting section 412 of the rack 41 and the support frame 112 to apply a biasing force to urge the spring latch 2 toward the projecting position and to keep the spring latch 2 in the projecting position.

The second compression spring 47 is disposed within the sleeve wall 421 of the sleeve 42, and has two ends abutting against the cover plate 12 and the bearing 45 to urge the bearing 45 to be in abutting engagement with the abutting surface 423 and to urge and keep the pinion 43 in mesh engagement with the rack section 411 of the rack 41. Thus, disengagement of the pinion 43 from the rack section 411 during swaying of the bearing 45 and the pinion 43 in the sleeve 42 is prevented.

With reference to FIGS. 4, 5 and 10, the housing shell 11 further has a beam 118 which is disposed on the base plate 110 below the pressed shaft 312 of the retaining member 31. The deadbolt assembly 5 is operably disposed in the accommodation space 10 of the housing 1, and includes a sliding plate 51 slidably connected with the housing 1, and a plurality of deadbolts 52 disposed on a front end of the sliding plate 51 and projecting from the housing 1. The deadbolts 52 are arranged in the vertical direction (D3), each projecting from the corresponding deadbolt hole 132. The deadbolt assembly 5 is operably moved between a locking position (as shown in FIG. 4), where a portion of each deadbolt 52 projects outwardly of the corresponding deadbolt hole 132, and an unlocking position (as shown in FIG. 12), where each deadbolt 52 retreats in the accommodation space 10 of the housing 1. The sliding plate 51 has a notch 512 which extends in a direction of movement of the deadbolt assembly 5, and first and second notch side surfaces 513, 514 which are opposite to each other in the direction of the movement to cooperatively define the notch 512. The first notch side surface 513 is interposed between the deadbolt 52 and the second notch side surface 514.

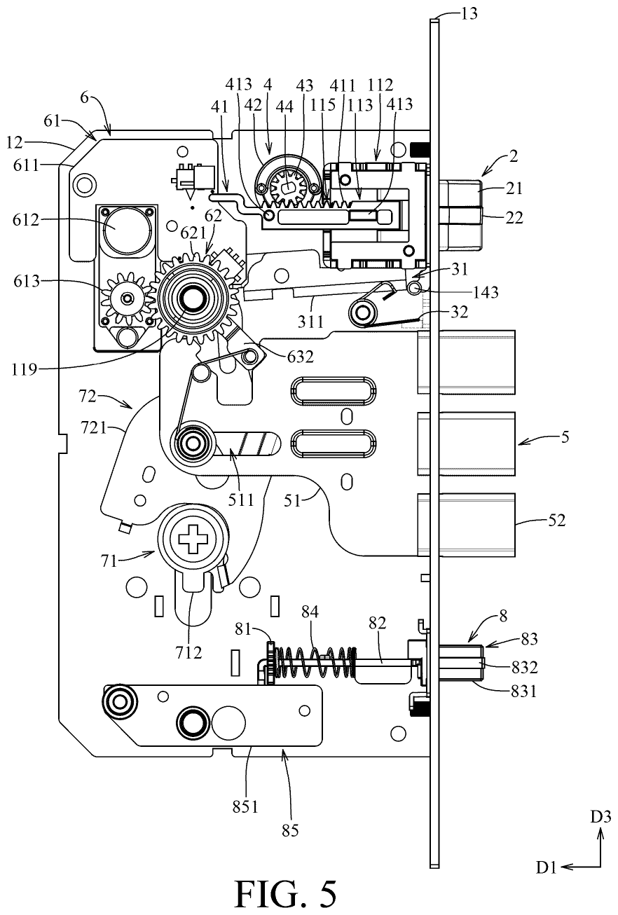

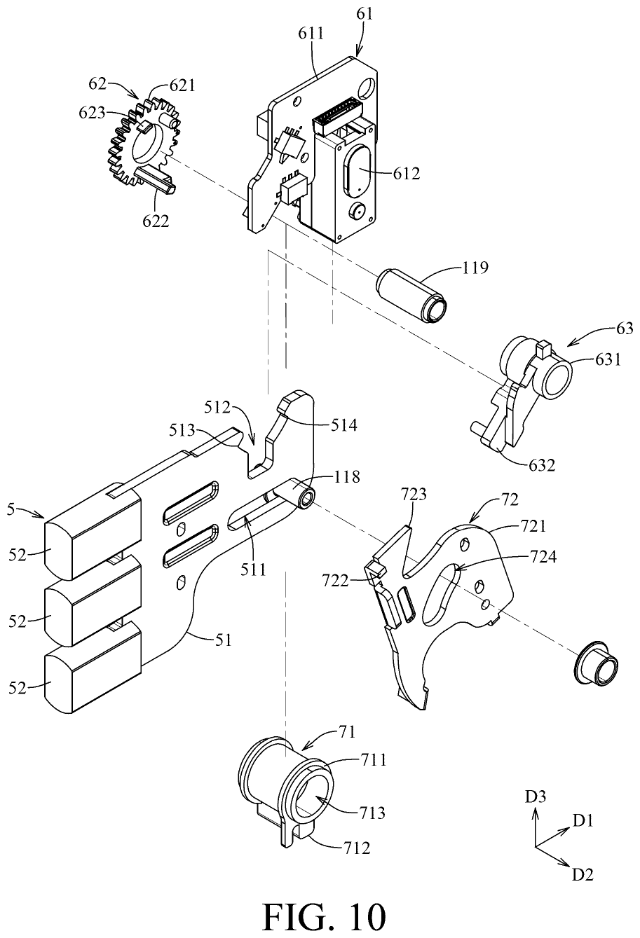

The housing shell 11 further has an upper pivot axle 119 disposed on the base plate 110 above the beam 118, and a lower pivot axle 120 disposed on the base plate 110 below and rearwardly of the beam 118. The electrically driving mechanism 6 is disposed in the accommodation space 10 of the housing 1, and includes an electrically driving assembly 61, a transmitting pinion 62 and a cam member 63. Referring to FIG. 5, the electrically driving assembly 61 has a circuit assembly 611, an electric motor 612 connected with the circuit assembly 611, and a gear assembly 613 coupled with the electric motor 612. The transmitting pinion 62 is pivotably connected with the upper pivot axle 119 and meshes with the gear assembly 613 to be driven by the electrically driving assembly 61 to rotate. Referring to FIGS. 4 and 10, the transmitting pinion 62 has a toothed portion 621 which is pivotably connected with the upper pivot axle 119 and meshes with the gear assembly 613, a first pressing protrusion 622 which projects from a right side of the toothed portion 621, and a second pressing protrusion 623 which projects from the right side of the toothed portion 621 and which is angularly spaced apart from the first pressing protrusion 622. The first pressing protrusion 622 is interposed between the transverse shaft section 314 of the pressed shaft 312 and the second pressing protrusion 623 to press the transverse shaft section 314 to rotate the retaining member 31 from the retaining position to the releasing position.

The cam member 63 has a pivot ring 631 which is pivotably connected with the upper pivot axle 119, and a press arm 632 which extends radially and outwardly from the pivot ring 631. The first pressing protrusion 622 is interposed between the pressed shaft 312 and the press arm 632. The press arm 632 is interposed between the first pressing protrusion 622 and the second pressing protrusion 623, and is engaged in the notch 512 of the sliding plate 51 to press the first notch side surface 513 of the sliding plate 51 to move the deadbolt assembly 5 toward the locking position, and to press the second notch side surface 514 to move the deadbolt assembly 5 toward the unlocking position. The cam member 63 is swingable, through driving of the transmitting pinion 62, between a first swung position (as shown in FIG. 4), where the deadbolt assembly 5 is in the locking position, and a second swung position (as shown in FIG. 12), where the deadbolt assembly 5 is in the unlocking position.

Furthermore, the first pressing protrusion 622 of the transmitting pinion 62 is disposed to press the press arm 632 to swing the cam member 63 from the second swung position to the first swung position. The second pressing protrusion 623 is disposed to press the press arm 632 to swing the cam member 63 from the first swung position to the second swung position.

The key driving mechanism 7 is disposed within the housing 1, and includes a rotary member 71 and a transmitting plate 72. The rotary member 71 is pivotably connected with the base plate 110 and the cover plate 12, and has a rotary cylinder 711 formed with a key hole 713, and a driving arm 712 extending radially and outwardly from the rotary cylinder 711. A key (not shown) is inserted into the key hole 713 and is operated to rotate the rotary member 71.

The transmitting plate 72 is pivotably connected with the lower pivot axle 120 and is rotated with the rotary member 71. The transmitting plate 72 has a plate body 721 which is pivotably connected with the lower pivot axle 120, and a pressing protuberance 722 which projects from a side surface of the plate body 721 adjacent to a top end of the plate body 721. The plate body 721 has a pressing edge 723 rearwardly of the pressing protuberance 722, and an arcuate slot 724 for the beam 118 to slidably extend therethrough. The pressing protuberance 722 is formed to press the upright shaft section 315 of the pressed shaft 312 so as to rotate the retaining member 31 from the retaining position to the releasing position. The pressing edge 723 is formed to press the press arm 632 to swing the cam member 63 from the first swung position to the second swung position.

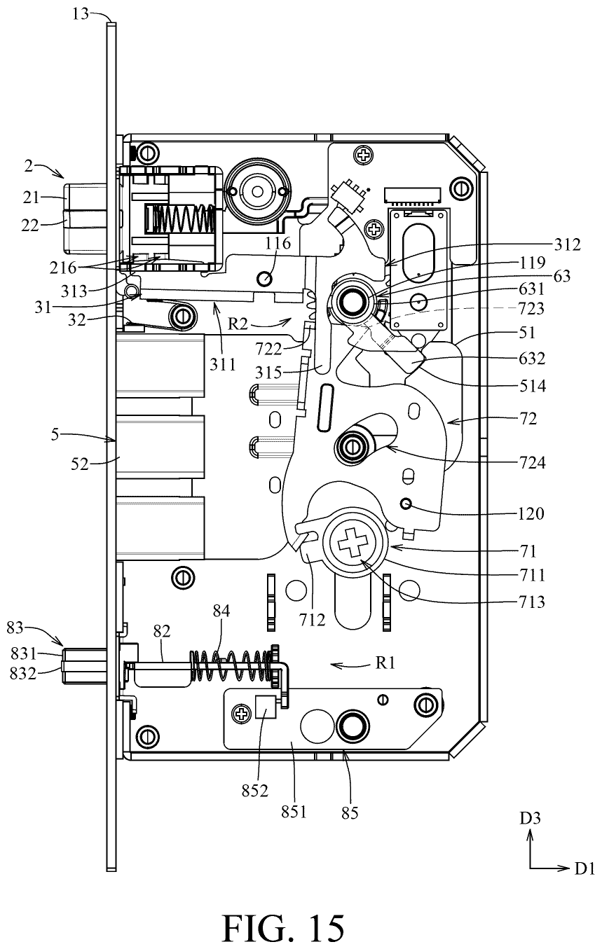

Specifically, with the rotation of the rotary member 71 by a key, the transmitting plate 72 is rotated between an initial position (as shown in FIG. 4), where the pressing edge 723 and the pressing protuberance 722 are respectively disengaged from the press arm 632 and the upright shaft section 315, and an abutting position (as shown in FIG. 15), where the pressing edge 723 is in abutting engagement with the press arm 632 to retain the cam member 63 in the second swung position, and where the pressing protuberance 722 is in abutting engagement with the upright shaft section 315 to retain the retaining member 31 in the releasing position.

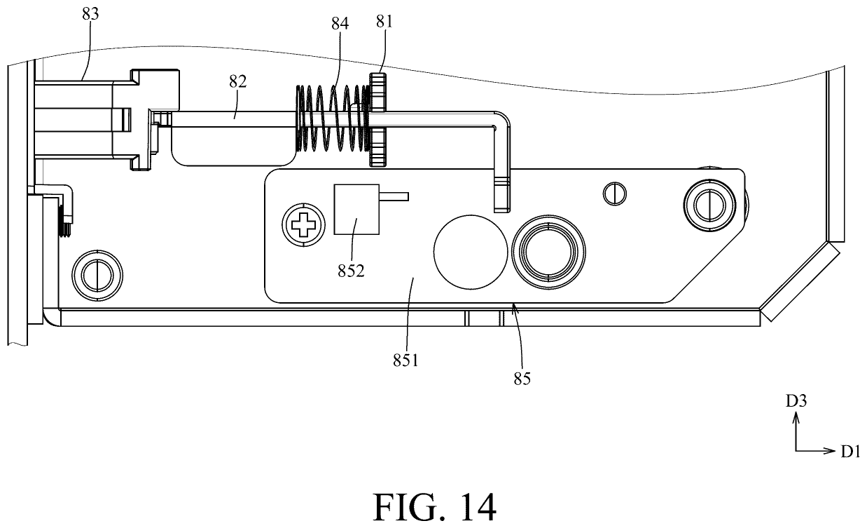

With reference to FIGS. 2, 4 and 5, the lock tongue mechanism 8 is disposed in the accommodation space 10 of the housing 1 and partly projects from the housing 1. The lock tongue mechanism 8 includes a mounting plate 81, a sliding rod 82, a tongue 83, a compression spring 84 and a sensing unit 85. The mounting plate 81 is disposed on the base plate 110 of the housing shell 11. The sliding rod 82 is slidably mounted on the mounting plate 81. The tongue 83 is pivotably connected with the sliding rod 82 and partly projects from the tongue hole 151. The compression spring 84 is sleeved around the sliding rod 82 and abuts against the sliding rod 82 and the mounting plate 81. The sensing unit 85 includes a circuit board 851 which is electronically connected with the circuit assembly 611 of the electrically driving assembly 61 in a wired or wireless manner, and a switch 852 which is disposed on the circuit board 851 to be in contact with the sliding rod 82. The tongue 83 is operable to move between an extended position (as shown in FIG. 4), where the tongue 83 partly projects from the housing 1 and the sliding rod 82 contacts the switch 852, and a retracted position (as shown in FIG. 14), where the tongue 83 retracts into the housing 1 and the sliding rod 82 is disengaged from the switch 852. The switch 852 generates a signal as the sliding rod 82 is disengaged from the switch 852, which is sent by the circuit board 851 to the circuit assembly 611 of the electrically driving assembly 61 to control the electrically driving assembly 61 to rotate the transmitting pinion 62. The transmitting pinion 62 brings the cam member 63 to swing to thereby press the deadbolt assembly 5 to the locking position.

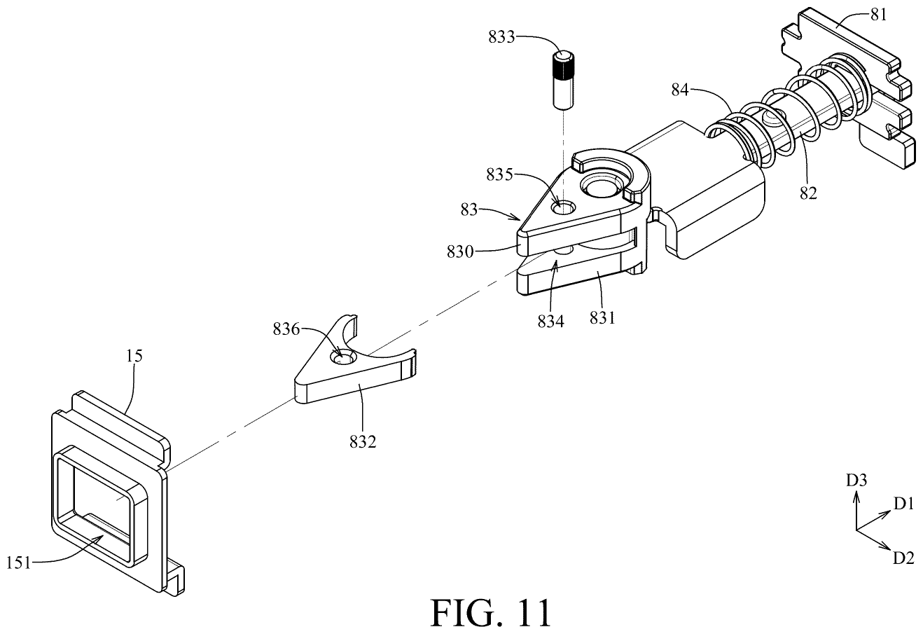

With reference to FIGS. 11, specifically, the tongue 83 includes a tongue body 831, a buffering pad 832 and an insert pin 833. The tongue body 831 has a substantially triangular cross-section, and is pivotably connected with the sliding rod 82. The tongue body 831 has an extended end 830 which projects outwardly of the tongue hole 151, a recess 834 which is recessed from the extended end 830, and an insert hole 835 which is in communication with the recess 834. The buffering pad 832 is made of an elastomeric material, such as rubber, silicone, etc., and is engaged in the recess 834 and partly projects from the tongue body 831 so as to contact the door frame (not shown). The buffering pad 832 has a through hole 836 which is aligned with the insert hole 835 in the vertical direction (D3). The insert pin 833 is engaged with and extends through the insert hole 835 and the through hole 836 to interfere with the tongue body 831 and the buffering pad 832 to retain the buffering pad 832 on the tongue body 831.

With reference to FIG. 12, when the door panel is in a door-opened state, the first pressing protrusion 622 of the transmitting pinion 62 abuts and presses a lower end of the transverse shaft section 314 of the retaining member 31 to retain the retaining member 31 in the releasing position. At this stage, the biasing spring 32 is compressed and deformed to create a biasing returning force. The second pressing protrusion 623 abuts and presses a front end of the press arm 632 to retain the cam member 63 in the second swung position. At this stage, the press arm 632 abuts and presses the second notch side surface 514 of the sliding plate 51 to retain the deadbolt assembly 5 in the unlocking position. Moreover, the spring latch 2 is kept in the projecting position, and the tongue 83 is kept in the extended position.

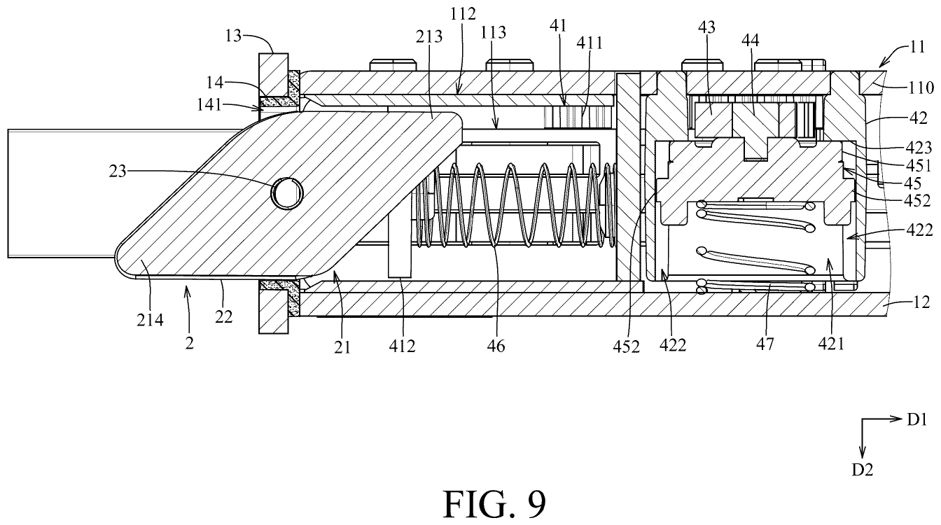

With reference to FIGS. 9, 12, 13 and 14, during rotation of the door panel to the door frame to the door-closed state, the buffering pad 22 of the spring latch 2 contacts the door frame, the spring latch 2 is rotated by the door frame and moved inwardly to the retreated position. During the rotation and movement of the spring latch 2, the rack 41 is slid inwardly to bring the pinion 43 to rotate, and the first compression spring 46 is compressed by the abutting section 412 of the rack 41 with a biasing returning force. With the frictional engagement of the pinion 43 with the rack section 411 and through controlling a friction force between the pinion shaft 44 and the bearing 45, and the first compression spring 46 having two ends abutting against the abutting section 412 and the support frame 112, the sliding movement of the rack 41 may be buffered and a speed of the sliding movement may be reduced so as to reduce noises generated during the retreated movement of the spring latch 2 and the rack 41.

Meanwhile, the tongue 83 contacts the door frame, and is pressed and rotated by the door frame to retract to the retracted position. The sliding rod 82 is slid inwardly during the rotation and movement of the tongue 83, and the compression spring 84 is compressed to create a biasing returning force. The sliding rod 82 is disengaged from the switch 852 such that the switch 852 generates a signal, which is sent by the circuit board 851 to the circuit assembly 611 of the electrically driving assembly 61.

With reference to FIGS. 4, 5 and 8, when the door panel is in the door-closed state, the rack 41 and the spring latch 2 are biased by the biasing returning force of the first compression spring 46 such that the spring latch 2 is rotated and moved outwardly to automatically return to the projecting position. At this stage, the spring latch 2 is retained in the door frame. Moreover, the circuit assembly 611 controls the operation of the electric motor 612 to rotate the transmitting pinion 62 in a first rotational direction (R1) through the gear assembly 613. During the rotation of the transmitting pinion 62, the first pressing protrusion 622 is moved away from the transverse shaft section 314, and the retaining member 31 is biased by the biasing returning force of the biasing spring 32 to automatically rotate about the axle shaft 116 in the first rotational direction (R1) to the retaining position. With the engagement of the retaining ribs 313 of the retaining member 31 with the corresponding first or second grooves 216, the spring latch 2 is retained in the projecting position to prevent rotation thereof.

Subsequently, the first pressing protrusion 622 abuts against and presses the press arm 632 of the cam member 63 to swing the cam member 63 in the first rotational direction (R1) from the second swung position. During swinging of the cam member 63, the press arm 632 presses the first notch side surface 513 of the sliding plate 51 to move the deadbolt assembly 5 in the first horizontal direction (D1) to the locking position. The rotation of the transmitting pinion 62 is stopped when the cam member 63 is swung to the first swung position, such that the cam member 63 is retained in the first swung position while the deadbolt assembly 5 is retained in the locking position where the deadbolts 52 are retained in the door frame. Thus, the door panel is locked to the door frame through the door lock device 100 (as shown in FIG. 1).

With reference to FIGS. 5 and 12, an unlocking operation of the door lock device 100 through the electrically driving mechanism 6 is described as follows. The circuit assembly 611 of the electrically driving assembly 61, when receiving an unlocking signal, controls the operation of the electric motor 612 to rotate the transmitting pinion 62 in a second rotational direction (R2) opposite to the first rotational direction (R1) through the gear assembly 613. During the rotation of the transmitting pinion 62, the first pressing protrusion 622 abuts against and presses the transverse shaft section 314 to rotate the retaining member 31 about the axle shaft 116 in the second rotational direction (R2), and the second pressing protrusion 623 abuts against and presses the press arm 632 to swing the cam member 63 in the second rotational direction (R2) from the first swung position. During the swinging of the cam member 63, the press arm 632 presses the second notch side surface 514 of the sliding plate 51 to move the deadbolt assembly 5 in the first horizontal direction (D1) toward the unlocking position. The rotation of the transmitting pinion 62 is stopped when the cam member 63 is swung to the second swung position, such that the retaining member 31 is retained in the releasing position, and the cam member 63 is retained in the second swung position while the deadbolt assembly 5 is retained in the unlocking position where the deadbolts 52 are moved away from the door frame.

With reference to FIGS. 1 and 15, an unlocking operation of the door lock device 100 through the key driving mechanism 7 is described as follows. The rotary member 71 is rotated in the first rotational direction (R1) through a key driving action. During the rotation of the rotary member 71, the driving arm 712 presses the transmitting plate 72 to rotate about the lower pivot axle 120 in the first rotational direction (R1) while the pressing protuberance 722 presses the upright shaft section 315 of the retaining member 31 to rotate the retaining member 31 about the axle shaft 116 in the second rotational direction (R2), and the pressing edge 723 presses the press arm 632 to swing the cam member 63 in the second rotational direction (R2). During the swing the cam member 63, the press arm 632 presses the second notch side surface 514 of the sliding plate 51 to move the deadbolt assembly 5 in the first horizontal direction (D1) toward the unlocking position. When the transmitting plate 72 is rotated to the abutting position, the retaining member 31 is retained in the releasing position, the cam member 63 is retained in the second swung position while the deadbolt assembly 5 is retained in the unlocking position where the deadbolts 52 are moved away from the door frame.

With reference to FIGS. 12, 13 and 15, in the above unlocking state of the door lock device 100, the door panel may be pushed away from the door frame. The buffering pad 22 of the spring latch 2 contacts and is pressed by the door frame, which brings the spring latch 2 to rotate and move inwardly to the retreated position. Once the door panel is opened, the spring latch 2 is urged by the biasing returning force of the first compression spring 46 to automatically move back to the projecting position. Additionally, the sliding rod 82 and the tongue 83 are urged by the biasing returning force of the compression spring 84 to bring the tongue 83 back to the extended position and the sliding rod 82 to contact the switch 852.

With reference to FIGS. 1, 4 and 6, during opening and closing of the door panel, with the buffering pad 22 and the buffering pad 832 contacting the door frame, the latch body 21 and the tongue body 831 may be prevented from direct collision with the door frame and generating noises so as to achieve a silent working effect. Moreover, with the buffering ring 14 stopping the protrusions 212 of the spring latch 2, the spring tongue 2 is prevented from disengagement from the latch hole 141 to retain the spring latch 2 in the projecting position, thereby achieving buffering and muffling effects in operation. Furthermore, with the buffering ring 15 stopping the tongue body 831 of the tongue 83 during rotation and movement of the tongue 83, the tongue 83 may be prevented from disengagement from the tongue hole 151 to retain the tongue 83 in the extended position, thereby achieving buffering and muffling effects.

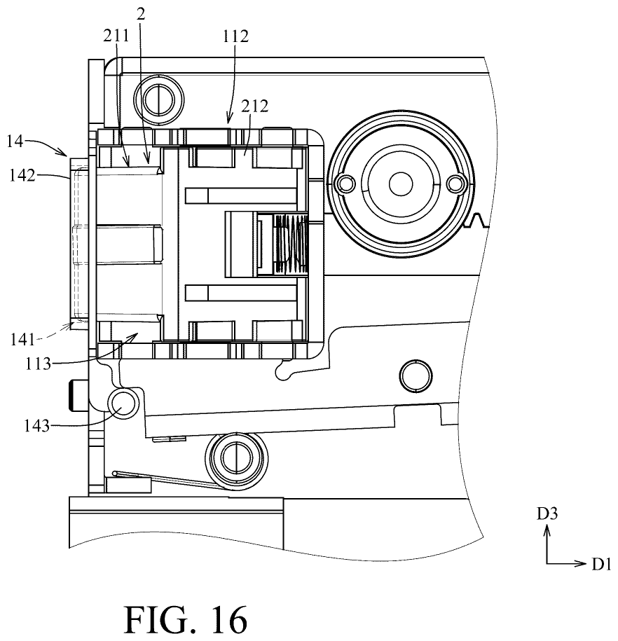

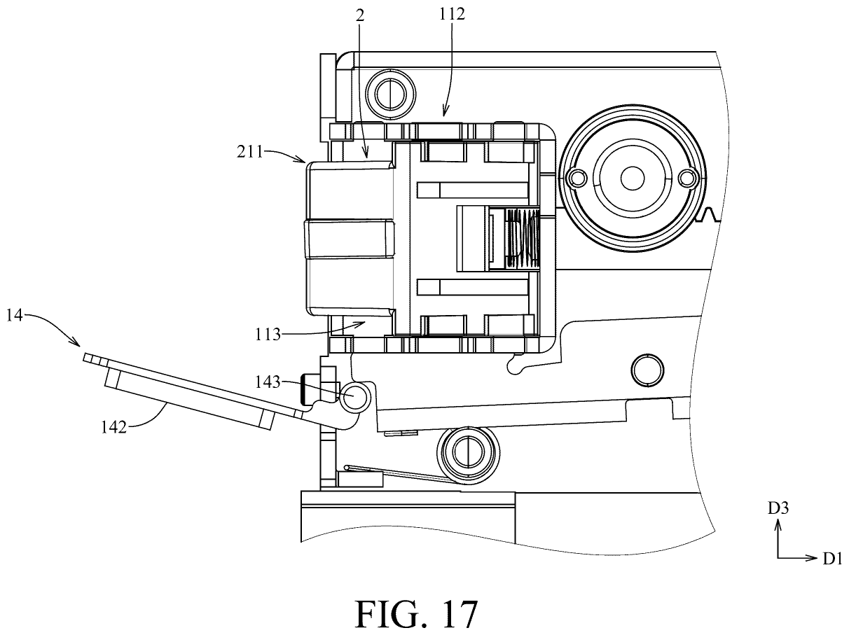

With reference to FIGS. 2, 3, 16 and 17, the base plate 110 of the housing shell 11 has a first axial hole (110a) below the support frame 112. The cover plate 12 has a second axial hole 121 aligned with the first axial hole (110a). The buffering ring 14 includes a ring body 142 which defines the latch hole 141, and a pivot axle 143 which is connected with a lower end of the ring body 142. The ring body 142 is disposed in the upper hole 131 of the front plate 13 to stop the protrusions 212. The pivot axle 143 is pivotably engaged in the first axle hole (110a) and the second axial hole 121. Thus, when the front plate 13 is removed from the housing shell 11 and the cover plate 12, the buffering ring 14 may be rotated relative to the housing shell 11 and the cover plate 12 between a closed position (as shown in FIG. 16) and an opened position (as shown in FIG. 17). In the closed position, the latch hole 141 is aligned with the upper hole 131 for projection of the diamond-shaped body 211 therethrough, and the ring body 142 is disposed to stop the protrusions 212. In the opened position, the latch hole 141 is moved away from and disengaged from the diamond-shaped body 211, and the buffering ring 14 is moved away and disengaged from the protrusions 212.

When it is desired to change the direction of the door lock device 100 so that the door lock device 100 may be applied to either one of the inward-opening door or the outward-opening door, the front plate 13 is firstly removed from the housing shell 11 and the cover plate 12 to disengage the buffering ring 14 from the upper hole 131. The spring latch 2 is then pressed inwardly to the retreated position to disengage the protrusions 212 from the ring body 142. Subsequently, the buffering ring 14 is pulled outwardly and is rotated to the opened position so as to disengage the latch hole 141 from the diamond-shaped body 211.

Next, the spring latch 2 is removed from the receiving space 113, is turned by 180 degrees, and is inserted into the receiving space 113. Then, the buffering ring 14 is pulled inwardly and rotated back to the closed position. Finally, the front plate 13 is mounted back on the housing shell 11 and the cover plate 12. With the spring latch 2 having a diamond-shaped cross-section, the spring latch 2 is mountable within the housing 1 in either the head-side direction or the tail-side direction, and is rotatable in the latch hole 141 and the receiving space 113. The spring latch 2 may be rotated and moved in the latch hole 141 and the receiving space 113 without any pivoting mechanism. Therefore, the structure of the spring latch 2 and the housing 1 is simple in reducing the manufacturing costs. Moreover, the direction changing operation of the spring latch 2 is simple and convenient to conduct.

In various embodiments, two pairs of the protrusions 212 are formed on the first and second side surfaces 215. Specifically, the protrusions 212 of each pair project from the corresponding one of the first and second side surfaces 215 and cooperatively define the corresponding one of the first and second grooves 216. The retaining shaft 311 has only one retaining rib 313.

Alternatively, the sleeve 42 has one engaging slot 422, and the bearing 45 has one engaging rib 452.

As illustrated, since the housing 1, the spring latch 2 and the retaining member 3 are configured and arranged in the above structural relationship, the door lock device 100 has a fewer number of components and is convenient to fabricate, and is simple and compact in structure in reducing the manufacturing costs. With the spring latch 2 being selectively mountable in the receiving space 113 in one of a head-side direction and a tail-side direction which is opposite to the head-side direction by a 180-degree spin, the door lock device 100 may be applied to both the inward-opening door and the outward-opening door. Through the buffering pads 22, 832 contacting the door frame, the latch body 21 and the tongue body 831 may be prevented from direct collision with the door frame and generating noises so as to achieve a silent working effect. With the buffering ring 14 stopping the protrusions 212 of the spring latch 2, the spring tongue 2 is prevented from disengagement from the latch hole 141, thereby achieving buffering and muffling effects in operation. Furthermore, with the buffering ring 15 stopping the tongue body 831 of the tongue 83, the tongue 83 may be prevented from disengagement from the tongue hole 151, thereby achieving buffering and muffling effects. With the speed-reduction mechanism 4, noises generated during the retreating movement of the spring latch 2 is reduced.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A door lock device, comprising:
a housing defining a receiving space therein, and having a latch hole in communication with said receiving space;
a spring latch rotatably and movably disposed in said receiving space adjacent to said latch hole to be pressed to rotate and move between a projecting position, where a portion of said spring latch projects outwardly of said latch hole, and a retreated position, where said spring latch retreats inwardly into said latch hole; and
a retaining biasing assembly disposed within said housing, said retaining biasing assembly including a retaining member which is pivotably disposed in said housing, and a biasing spring, said retaining member being operable to rotate between a retaining position, where said retaining member is engaged with said spring latch to prevent rotation of said spring latch in the projecting position, and a releasing position, where said retaining member is disengaged from said spring latch, said biasing spring being disposed to bias said retaining member to the retaining position and to keep said retaining member in the retaining position.

2. The door lock device of claim 1, wherein said spring latch has a diamond-shaped cross-section, and is removably disposed within said housing such that said spring latch is selectively disposed in said receiving space in one of a head-side direction and a tail-side direction which is opposite to the head-side direction by a 180-degree spin.

3. The door lock device of claim 2, wherein said spring latch has a first groove and a second groove opposite to each other, said retaining member being engaged with said first groove when said spring latch is disposed in the head-side direction, and being engaged with said second groove when said spring latch is disposed in the tail-side direction.

4. The door lock device of claim 3, wherein said housing includes a buffering ring, said buffering ring defining said latch hole extending therethrough, said spring latch having a diamond-shaped body and at least two pairs of said protrusions, said diamond-shaped body being disposed in said receiving space and extendable through said latch hole, said diamond-shaped body having two side surfaces opposite to each other, said protrusions of each pair projecting from a corresponding one of said side surfaces and cooperatively defining a corresponding one of said first groove and said second groove, said buffering ring being disposed to stop said protrusions during rotation and movement of said spring latch to retain said spring latch in the projecting position.

5. The door lock device of claim 4, wherein said buffering ring is rotatable between a closed position, where said latch hole is disposed for projection of said diamond-shaped body therethrough, and said buffering ring is disposed to stop said protrusions, and an opened position, where said latch hole is moved away and disengaged from said diamond-shaped body, and said buffering ring is moved away and disengaged from said protrusions.

6. The door lock device of claim 5, wherein said housing includes a housing shell having a right opening, a cover plate coupled with said housing shell to cover said right opening, and a front plate removably connected with front ends of said housing shell and said cover plate, said housing shell having a first axial hole, said cover plate having a second axial hole, said front plate having an upper hole, said buffering ring including a ring body which defines said latch hole and which is mounted on said front plate to align said latch hole with said upper hole and to stop said protrusions, and a pivot axle which is connected with said ring body and which is pivotably disposed in said first axial hole and said second axial hole such that, when said front plate is removed from said housing shell and said cover plate, said buffering ring is rotatable relative to said housing shell and said cover plate between the closed position and the opened position.

7. The door lock device of claim 1, wherein said spring latch includes a latch body and a buffering pad which is disposed on said latch body, said latch body including an outer part which has a projecting end projecting outwardly of said latch hole, a recess recessed from said projecting end, and an insert hole in communication with said recess, said buffering pad being engaged in said recess and partly projecting from said outer part, said buffering pad having a through hole which is aligned with said insert hole, said spring latch further including an insert pin which is engaged with and extends through said insert hole and said through hole to retain said buffering pad on said latch body.

8. The door lock device of claim 1, further comprising a speed-reduction mechanism disposed within said housing, said speed-reduction mechanism including a rack, a pinion, a pinion shaft and a bearing, said rack being slidably disposed on said housing and having an end in abutting engagement with said spring latch to be moved with said spring latch, said pinion being securely sleeved on said pinion shaft and meshing with said rack, said bearing being disposed to bear said pinion shaft.

9. The door lock device of claim 8, wherein said speed-reduction mechanism further includes a first compression spring having an end in abutting engagement with said rack to apply a biasing force to urge said spring latch toward the projecting position.

10. The door lock device of claim 8, wherein said speed-reduction mechanism further includes a sleeve and a second compression spring, said sleeve being disposed on said housing for receiving said bearing therein, and having an abutting surface which is disposed therein, said second compression spring being disposed in said sleeve and abutting against said housing and said bearing to urge said bearing to be in abutting engagement with said abutting surface and urge said pinion in mesh engagement with said rack, said sleeve having at least one engaging slot, said bearing having at least one engaging rib which is engaged with said engaging slot to retain said bearing on said sleeve.

11. The door lock device of claim 1, further comprising a deadbolt assembly and an electrically driving mechanism, said deadbolt assembly being operably disposed within said housing to be operably moved between a locking position, where a portion of said deadbolt assembly projects outwardly of said housing, and an unlocking position, where said deadbolt assembly retreats in said housing, said electrically driving mechanism including an electrically driving assembly, a transmitting pinion which is pivotably connected with said housing and which is driven by said electrically driving assembly to rotate, and a cam member which is pivotably connected with said housing and which is swingable through said transmitting pinion, said transmitting pinion being rotated to press said retaining member to rotate from the retaining position to the releasing position, said cam member being swung to press said deadbolt assembly to move between the locking position and the unlocking position.

12. The door lock device of claim 11, wherein said retaining member is an integrally formed single piece, said retaining member having a retaining shaft disposed to retain said spring latch, and a pressed shaft extending from said retaining shaft, said cam member having a press arm which presses said deadbolt assembly such that said cam member being swingable between a first swung position, where said deadbolt assembly is in the locking position, and a second swung position, where said deadbolt assembly is in the unlocking position, said transmitting pinion having a toothed portion which is coupled with and driven by said electrically driving assembly, a first pressing protrusion which projects from a side of said toothed portion and which is interposed between said pressed shaft and said press arm, and a second pressing protrusion which projects from said side of said toothed portion and which is angularly spaced apart from said first pressing protrusion, said press arm being interposed between said first pressing protrusion and said second pressing protrusion, said first pressing protrusion pressing said pressed shaft to rotate said retaining member from the retaining position to the releasing position, and also pressing said press arm to swing said cam member from the second swung position to the first swung position, said second pressing protrusion pressing said press arm to swing said cam member from the first swung position to the second swung position.

13. The door lock device of claim 12, wherein said deadbolt assembly includes a sliding plate slidably connected with said housing, and at least one deadbolt disposed on said sliding plate and projecting from said housing, said sliding plate having a notch which extends in a direction of movement of said deadbolt assembly, and a first notch side surface and a second notch side surface which are opposite to each other in the in direction of the movement to cooperatively define said notch, said first notch side surface being interposed between said deadbolt and said second notch side surface, said press arm being engaged in said notch to press said first notch side surface to move said deadbolt assembly toward the locking position, and to press said second notch side surface to move said deadbolt assembly toward the unlocking position.

14. The door lock device of claim 12, wherein said pressed shaft includes a transverse shaft section to be pressed by said first pressing protrusion, and an upright shaft section extending transverse to said transverse shaft section, said door lock device further comprising a key driving mechanism disposed within said housing, said key driving mechanism including a rotary member which is pivotably connected with said housing, and a transmitting plate which is pivotably connected with said housing and which is rotated with said rotary member to press said upright shaft section to rotate said retaining member from the retaining position to the releasing position, said transmitting plate also pressing said press arm to swing said cam member from the first swung position to the second swung position.

15. The door lock device of claim 14, wherein said transmitting plate has a plate body which is pivotably connected with said housing, and a pressing protuberance which projects from a side surface of said plate body and which is formed to press said upright shaft section, said plate body having a pressing edge which is formed to press said press arm, said transmitting plate being rotated with said rotary member between an initial position, where said pressing edge and said pressing protuberance are respectively disengaged from said press arm and said upright shaft section, and an abutting position, where said pressing edge is in abutting engagement with said press arm to retain said cam member in the second swung position, and where said pressing protuberance is in abutting engagement with said upright shaft section to retain said retaining member in the releasing position.

16. The door lock device of claim 1, further comprising a key driving mechanism disposed within said housing, said key driving mechanism including a rotary member which is pivotably connected with said housing, and a transmitting plate which is pivotably connected with said housing and which is rotated with said rotary member to press and rotate said retaining member from the retaining position to the releasing position, said retaining member having a retaining shaft disposed to retain said spring latch, and a pressed shaft extending from said retaining shaft to be pressed by said transmitting plate.

17. The door lock device of claim 11, further comprising a lock tongue mechanism which is disposed within said housing and partly projecting from said housing, said lock tongue mechanism being electronically connected with said electrically driving assembly such that said lock tongue mechanism generates a signal as a result of a contact changing action, which is sent to and controls said electrically driving assembly to bring rotation of said transmitting pinion so as to swing said cam member and press said deadbolt assembly to the locking position.

18. The door lock device of claim 17, wherein said lock tongue mechanism includes a mounting plate disposed on said housing, a sliding rod slidably mounted on said mounting plate, a tongue pivotably connected with said sliding rod and partly projecting from said housing, a compression spring sleeved around said sliding rod and abutting against said sliding rod and said mounting plate, and a sensing unit, said sensing unit including a circuit board which is electronically connected with said electrically driving assembly, and a switch which is disposed on said circuit board to be in contact with said sliding rod, wherein said tongue is operable to move between an extended position, where said tongue partly projects from said housing and said sliding rod contacts said switch, and a retracted position, where said tongue retracts into said housing and said sliding rod is disengaged from said switch, and wherein said switch generates the signal as said sliding rod is disengaged from said switch, which is sent by said circuit board to said electrically driving assembly.

19. The door lock device of claim 18, wherein said housing includes a buffering ring, said buffering ring defining a tongue hole extending therethrough, said buffering ring being disposed to stop said tongue during rotation and movement of said tongue to retain said tongue in the extended position.

20. The door lock device of claim 18, wherein said tongue includes a tongue body and a buffering pad which is disposed on said tongue body, said tongue body having an extended end projecting outwardly of said tongue hole, a recess recessed from said extended end, and an insert hole in communication with said recess, said buffering pad being engaged in said recess and partly projecting from said tongue body, said buffering pad having a through hole which is aligned with said insert hole, said tongue further including an insert pin which is engaged with and extends through said insert hole and said through hole to retain said buffering pad on said tongue body.
